(19) United States
(12) Patent Application Publication
(10) Pub. No.: US 2015/0165643 A1
(43) Pub. Date: Jun. 18, 2015

(54) MILLING MACHINE AND SYSTEM FOR PRODUCING SYNTHETIC WOOD

(71) Applicant: Wubing Dai, Beijing (CN)

(72) Inventor: Wubing Dai, Beijing (CN)

(21) Appl. No.: 14/380,651

(22) PCT Filed: Mar. 14, 2012
(86) PCT No.: PCT/CN2012/072334

§ 371 Date: Nov. 12, 2014

(30) Foreign Application Priority Data
Feb. 23, 2012 (CN) 201210042951.6

(51) Int. Cl. B27L 11/00; B30B 3/04; B27N 3/24; B27L 5/00; B27N 3/18

(52) U.S. Cl. CPC B27L 11/007; B27L 11/005; B27L 5/00; B27N 3/18; B27N 3/24; B30B 3/04

(57) ABSTRACT

The present invention discloses a wood milling machine, comprising a compression device (10), which comprises an upper roller (11) and a lower roller (12) rotating in opposite directions, with a gap between the upper roller (11) and the lower roller (12). The present invention further provides a system for producing synthetic wood that comprises the milling machine. The milling machine described in the present invention comprises an upper roller and a lower roller, wood is compressed between the upper roller and the lower roller so that wood fibers are obtained without destroying the original structure of wood fibers. The performance of synthetic wood made from processed wood fibers is approximately equivalent to that of real wood. In addition, with the system for producing synthetic wood described in the present invention, no formaldehyde has to be added in the synthetic wood production process, the production cost of synthetic wood is reduced, and a purpose of energy conservation and environmental protection is realized.

### TECHNICAL FIELD

The present invention relates to the wood processing field, in particular to a milling machine and a system for producing synthetic wood that comprises the milling machine.

### BACKGROUND

A decorative board, which is also referred to as a veneer board, is a single-face or double-face decoration panel. The decorative board is produced by slicing a solid wood board accurately into thin wood veneers with 0.1 mm or more thickness, and then gluing the wood veneers onto a plywood board that serves as a substrate.

Formaldehyde has strong adhesiveness, which can strengthen the hardness of the boards and has the functions of insect prevention and wood preservation. Therefore, it is generally used that the resin binder containing formaldehyde as a main component. Under the coaction of ultraviolet radiation, high temperature, and sun light, the above binder will be decomposed and release formaldehyde into in the indoor air. Since the decomposing process of the binder is happening continually, formaldehyde will be consistently released to the environment, which is the main cause of the indoor formaldehyde.

Formaldehyde is a colorless and irritating gas with a strong smell. The 35%-40% water solution of formaldehyde is known as formalin. Formaldehyde is a protoplasmic toxin, which can bind with protein. Inhaling of high-concentration formaldehyde may cause severe respiratory tract irritation and edema, eye stinging, headache, or bronchial asthma. Direct contact with formaldehyde of skin may cause dermatitis, color spots, or necrosis. Frequent inhalation of formaldehyde in a small amount may cause chronic intoxication, mucosal hyperemia, skin irritation, allergic dermatitis, nail keratization and brittleness, or nail bed and fingertip pain, etc.

In Patent Publication No. CN 101554741B, a formaldehyde-free decorative board is disclosed, which is produced by pressure pasting a plurality of wood veneers (medium plates) with binder, wherein, the binder is a formaldehyde-free plastic film. Since no formaldehyde is added in the production process of the decorative board, the formaldehyde-free decorative board essentially has no poisoning effect to human body or pollution to the ambient environment, and is truly environment friendly. However, a great deal of wood is still required and the cost is high if the wood veneers (medium plate) are produced in mass production from wood obtained from fast-growing forests.

Salix mongolia is an shrub species that has favorable wind prevention and sand fixation function growing in desert regions, with a growing period as long as 20 years. Salix mongolia must be stumped once every 3-4 years; otherwise it will wither gradually and even die. In recent years, it has appeared the techniques of utilizing salix mongolia fibers to produce fiber boards emerged.

In Patent Publication No. CN101148058, a type of salix mongolia composite synthetic wood and a method for producing the same are disclosed, wherein, the synthetic wood is obtained by mixing an adhesive with salix mongolia fibers and coal ash and then hot-pressing the mixture. The fibers of salix mongolia in the synthetic wood are obtained by hot-grinding or hammering salix mongolia, so the fibers are short. Therefore, the synthetic wood has poor processability. In addition, the manufacturing process of the synthetic wood is complex, and the production cost is high.

Therefore, how to reduce the production cost of synthetic wood is an urgent technical task to be solved in the art.

### SUMMARY OF THE INVENTION

The object of the present invention is to provide a milling machine and a system for producing synthetic wood that comprises the milling machine. With the milling machine, long wood fibers can be obtained; with the production system, formaldehyde-free synthetic wood can be produced at a low cost.

To attain the object described above, the present invention on one hand provides a wood milling machine, comprising a compression device, wherein, the compression device comprises an upper roller and a lower roller rotating in opposite directions with a gap between thereof.

Preferably, the gap between the upper roller and the lower roller is adjustable.

Preferably, the compression device comprises a plurality of upper rollers arranged side by side in a row and a plurality of lower rollers arranged side by side in a row.

Preferably, the compression device comprises an upper frictional belt surrounding the plurality of upper rollers and a lower frictional belt surrounding the plurality of lower rollers, wherein, the upper frictional belt can be driven by the upper rollers to move, and the lower frictional belt can be driven by the lower rollers to move, moreover, there is a gap between a side of the upper frictional belt and a side of the lower frictional belt that face each other.

Preferably, the gap between the side of the upper frictional belt and the side of the lower frictional belt that face each other decreases gradually from the upstream to the downstream.

Preferably, the outer surface of the upper frictional belt and/or the upper surface of the lower frictional belt have patterns, to increase the friction force between the wood and the upper frictional belt and/or lower frictional belt.

Preferably, the movement speed of the upper frictional belt is not equal to that of the lower frictional belt.

Preferably, the milling machine comprises a first speed regulating device designed to regulate the rotation speed of the upper rollers, and/or a second speed regulating device designed to regulate the rotation speed of the lower rollers.

Preferably, the milling machine comprises a first motor designed to drive the upper rollers to rotate, and/or the a second motor designed to drive the lower rollers to rotate, wherein, the speed regulating device is a first frequency converter electrically connected to the first motor, and the second speed regulating device is a second frequency converter electrically connected to the second motor.

Preferably, a tension pulley is arranged on the upper frictional belt and/or the lower frictional belt.

Preferably, the milling machine comprises a material feeding device with a wood channel, wherein, the material feeding device is arranged in upstream of the compression device, and the wood channel communicates with the gap between the side of the upper frictional belt and the side of the lower frictional belt that face each other.

Preferably, the milling machine comprises an die arranged at the outlet of the compression device, and the die communicates with the gap between the side of the upper frictional belt and the side of the lower frictional belt that face each other.

Preferably, the width of the die is equal to the width of the gap between the side of the upper frictional belt and the side of the lower frictional belt that face each other.

In another aspect of the present invention, the present invention provides a system for producing synthetic wood, comprising a milling machine, a first compression machine and a second compression machine, which are arranged sequentially from upstream to downstream, wherein, the milling machine is the above-mentioned milling machine provided in the present invention, and the first compression machine is equipped with a heating device designed to heat up templates of the first compression machine.

Preferably, the production system comprises a conveyer belt disposed between the milling machine and the first compression machine, and a glue spraying device is arranged above the conveyer belt.

Preferably, the glue spraying device is a glue line extruding machine.

Preferably, the production system comprises a drying device, which is arranged in downstream of the glue spraying device and adjacent to the glue spraying device in a way that the conveyer belt can move through the drying device.

Preferably, the drying device is an infrared-ray dryer.

Preferably, the production system comprises a cutting device, which is adjacently arranged in upstream of the first compression machine.

The milling machine described in the present invention comprises an upper roller and a lower roller, wherein, wood is compressed between the upper roller and the lower roller so that wood fibers are obtained without destroying the original structure of wood fibers. The performance of synthetic wood made from processed wood fibers is approximately equivalent to that of real wood. In addition, there is no formaldehyde added in the synthetic wood produced by the system for producing synthetic wood described in the present invention, the production cost of synthetic wood is reduced, and a purpose of energy conservation and environmental protection is realized.

Other characteristics and advantages of the present invention will be further detailed in the embodiments hereunder.

### BRIEF DESCRIPTION OF THE DRAWINGS

The accompanying drawings are provided here to facilitate further understanding on the present invention, and are a part of this document. They are used in conjunction with the following embodiments to explain the present invention, but shall not be comprehended as constituting any limitation to the present invention.

Among the drawings:

FIG. 1 is a schematic diagram of the milling machine according to the present invention;

FIG. 2 is a schematic diagram of the production process of a system for producing synthetic wood that comprises the milling machine shown in FIG. 1;

FIG. 3 is a schematic diagram of the wood fibers before being hot-compressed; and

FIG. 4 is a schematic diagram of the wood fibers after being cold-compressed.

### DETAILED DESCRIPTION OF THE EMBODIMENTS

Hereunder the embodiments of the present invention will be detailed, with reference to the accompanying drawings. It should be appreciated that the embodiments described here are only provided to describe and explain the present invention, but shall not be deemed as constituting any limitation to the present invention.

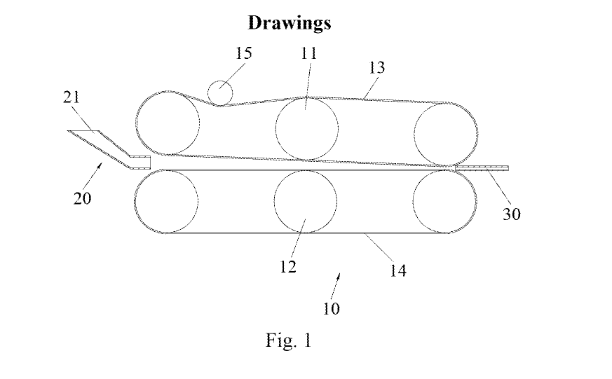

As shown in FIG. 1, in an aspect of the present invention, the present invention provides a wood milling machine, comprising a compression device 10, wherein, the compression device 10 comprises an upper roller 11 and a lower roller 12 rotating in opposite directions with a gap between thereof.

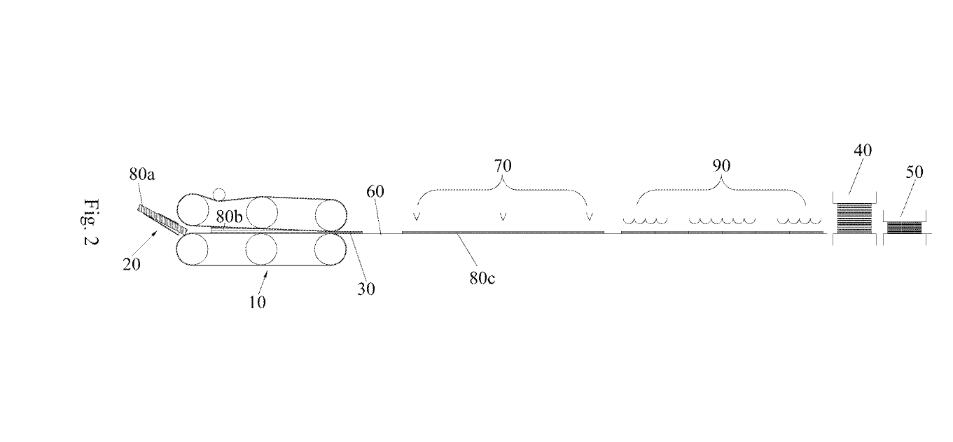

As shown in FIG. 2, the gap between the upper roller 11 and the lower roller 12 is smaller than the diameter (or thickness) of the wood 80a to be processed. The wood 80a is fed into the gap between the upper roller 11 and the lower roller 12, and the rotating upper roller 11 and lower roller 12 squeeze the wood 80a, so as to obtain wood 80b in the milling process. There is friction force between the wood 80b and the upper roller 11 and lower roller 12, which drives the wood 80b to move towards the downstream of the compression device 10. In the milling process, the wood 80b is subject to downward pressure and friction force towards the downstream of the compression device 10, so that integral wood fibers can be obtained. Synthetic wood made from the wood fibers have high tenacity and nail-holding capacity, and its performance is almost equivalent to that of real wood.

There is another advantage of milling the wood 80a with the milling machine described in the present invention, i.e., the wood fibers from the compression device are adhered to each other. Therefore, the binder consumption in the follow-up processing process can be reduced.

The milling machine described in the present invention is applicable to mill salix mongolia, so that the cost of synthetic wood can be reduced. Wood fibers of salix mongolia have high tenacity. However, in the prior art, means such as hot-grinding or hammering (see the disclosure in CN101148058A) are usually utilized to obtain wood fibers of salix mongolia. However, only short wood fibers of salix mongolia can be obtains by hot grinding or hammering, and synthetic wood made from short wood fibers of salix mongolia has poor nail-holding capacity and tenacity, which is to say, the advantages of wood fibers of salix mongolia can't be utilized fully. In contrast, long wood fibers of salix mongolia can be obtained by milling salix mongolia with the milling machine described in the present invention, and synthetic wood made from the long wood fibers of salix mongolia has tenacity and nail-holding capacity comparable to those of real wood. That aspect will be further detailed later.

Preferably, the gap between the upper roller 11 and the lower roller 12 is adjustable. Thus, the milling machine described in the present invention can adapt to wood materials in different diameters. To adjust the gap between the upper roller 11 and the lower roller 12, a gap adjusting device connected with the upper roller 11 and/or the lower roller 12 can be arranged in the compression device 10. For example, the gap adjusting device can be a hydraulic adjusting device or a mechanical screw adjusting device, as long as it can adjust the gap between the upper roller 11 and the lower roller 12.

The compression device 10 can comprise only one upper roller 11 and only one lower roller 12, alternatively, it can comprise a plurality of upper rollers 11 and a plurality of lower rollers 12. To enable continuous wood milling operation and ensure the wood can be milled into fibers more completely, preferably the compression device 10 comprises a plurality of upper rollers 11 arranged side by side in a row and a plurality of lower rollers 12 arranged side by side in a row. As shown in FIG. 1 and FIG. 2, “side by side” refers to that a plurality of upper rollers 11 and a plurality of lower rollers 12 are arranged sequentially from upstream to downstream of the compression device respectively. Preferably, the central axises of the plurality of upper rollers 11 and the central axises of the plurality of lower rollers 12 are respectively parallel to each other. Though the milling machine shown in FIG. 1 and FIG. 2 comprises three upper rollers 11 and three lower rollers, it should be appreciated that the milling machine can comprise two upper rollers 11 and two lower rollers 12 or comprise even more upper rollers 11 and even more lower rollers 12.

To prevent the fibers of the milled wood from escaping through the clearance between the plurality of lower rollers 12, preferably, the compression device 10 comprises an upper frictional belt 13 surrounding the plurality of upper rollers 11 and a lower frictional belt 14 surrounding the plurality of lower rollers 12, wherein, the upper frictional belt 13 can be driven by the upper rollers 11, and the lower frictional belt 14 can be driven by the lower rollers 12, and there is a gap between a side of the upper frictional belt 13 and a side of the lower frictional belt 14 that face each other. There is another advantage obtained by arranging an upper frictional belt 13 and a lower frictional belt 14: the friction force towards the downstream of the compression device 10 on the wood 80b in the milling process can be increased, which is more helpful for milling the wood 80b into longer fibers without destroying fiber integrality.

The upper frictional belt 13 and lower frictional belt 14 can be made of a metallic material or rubber material, as long as they have enough strength to mill the wood into fibers and create friction force between them and the wood.

To mill the wood 80b completely to obtain finer fibers, preferably the gap between the side of the upper frictional belt 13 and the side of the lower frictional belt 14 that face each other decreases gradually from upstream to downstream. A compression device 10 with the structure described above is helpful for compacting the fibers, so that the fibers from the compression device 10 have formed a relatively dense board; thus, the wood fibers 80c will not get loose in the follow-up process, and the consumption of the binder can be reduced.

Preferably, the outer surface of the upper frictional belt 13 and/or the upper surface of the lower frictional belt 14 have patterns, to increase the friction force between the wood and the upper frictional belt 13 and/or lower frictional belt 14. The patterns can be protrusions formed on the upper frictional belt 13 and/or lower frictional belt 14. Preferably, the patterns can have a stripe structure, and the extension direction of the strip patterns is inclined to the movement direction of the upper frictional belt 13 and/or lower frictional belt 14.

The movement speed of the upper frictional belt 13 can be equal to that of the lower frictional belt 14 or not. To ensure wood fiber integrality and obtain longer fibers, preferably the movement speed of the upper frictional belt 13 is not equal to that of the lower frictional belt 14.

Preferably, the milling machine can further comprise a first speed regulating device designed to regulate the rotation speed of the upper rollers 11, and/or a second speed regulating device designed to regulate the rotation speed of the lower rollers 12. Thus, the rotation speed of the upper roller 11 and/or lower roller 12 can be regulated as required.

Usually, the milling machine can comprise a first motor designed to drive the upper roller 11 to rotate, and the first speed regulating device can be a gear transmission. To simplify the structure of the milling machine and accurately control the speed of the upper frictional belt 13, preferably the first speed regulating device can be a first frequency converter electrically connected to the first motor. The output rotation speed of the first motor can be regulated by the first frequency converter, and thereby the rotation speed of the upper roller 11 can be regulated, and finally the movement speed of the upper frictional belt 13 can be regulated. Likewise, the milling machine can comprise a second motor designed to drive the lower roller 12, and the second speed regulating device can be a second frequency converter electrically connected to the second motor. The output rotation speed of the second motor can be regulated by the second frequency converter, and thereby the rotation speed of the lower roller 12 can be regulated, and finally the movement speed of the lower frictional belt 14 can be regulated.

To ensure the tension intensity of the upper frictional belt 13 and/or lower frictional belt 14 and ensure an normal operation of the compression device 10, preferably a tension pulley 15 is arranged on the upper frictional belt 13 and/or lower frictional belt 14. It should be appreciated that, although it's only shown a tension pulley on the upper frictional belt 13 is shown in FIG. 1, the lower frictional belt 14 can also be equipped with a tension pulley 15.

To ensure that the wood 80a to be processed can be easily fed into the gap between the upper roller 11 and the lower roller 12 (or the gap between the side of the upper frictional belt 13 and the side of the lower frictional belt 14 that face each other), preferably the milling machine comprises a material feeding device 20 with a wood channel 21, wherein, the material feeding device 20 is arranged in upstream of the compression device 10, and the wood channel 21 communicates with the gap between the side of the upper frictional belt 13 and the side of the lower frictional belt 14 that face each other. When being processed, the wood 80a can be fed into the material feeding device 20, then, the wood 80a is guided by the wood channel 21 in the material feeding device 20 into the gap between the upper roller 11 and the lower roller 12 (or the gap between the side of the upper frictional belt 13 and the side of the lower frictional belt 14 that face each other), so that the wood is milled to obtain wood fibers.

To further compact the wood fibers after milling operation, preferably the milling machine comprises an die 30 arranged at the outlet of the compression device 10, and the die 30 communicates with the gap between the side of the upper frictional belt 13 and the side of the lower frictional belt 14 that face each other. The wood fibers enter into the die 30 after being outputted from the compression device 10, and are further compacted by the die 30. The cross section of the wood fibers outputted from the die 30 is in the same shape as the outlet of the die 30, which is more helpful for wood fiber processing in the follow-up process (e.g., cutting process), and the consumption of the binder can be reduced further.

Preferably, the width of the die 30 is equal to the width of the gap between the side of the upper frictional belt 13 and the side of the lower frictional belt 14 that face each other. Thus, the wood fibers can enter into the die 30 directly for compression after being outputted from the gap.

In another aspect of the present invention, as shown in FIG. 2, the present invention provides a system for producing synthetic wood, comprising a milling machine, a first compression machine 40, and a second compression machine 50, which are arranged sequentially from upstream to downstream, wherein, the milling machine is the above-mentioned milling machine provided in the present invention, and the first compression machine 40 is equipped with a heating device designed to heat up templates of the first compression machine 40.

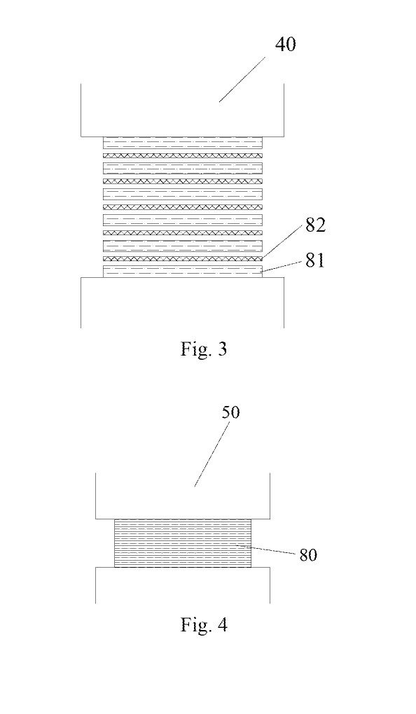

When the system for producing synthetic wood described in the present invention is used to produce synthetic wood, the wood 80a to be processed (e.g., salix mongolia) is firstly fed into the milling machine and compressed by the compression device 10 into wood fibers 80c. And then several layers of wood fibers are stacked, and a formaldehyde-free plastic film 82 is provided between two adjacent layers of wood fibers 80c. Next, the stacked wood fibers and plastic films 82 are placed between two templates of the first compression machine 40 and hot compressed by the two templates (as shown in FIG. 3). Since the first compression machine 40 comprises a heating device designed to heat up the templates, the plastic films 82 are melted in the compression process.

After the plastic films 82 are melted, as shown in FIG. 4, the wood fibers and molten plastic films are cold-compressed in the second compression machine 50, so that the molten plastic films are cured again and bind the wood fibers together. Therefore, synthetic wood 80 is obtained.

After synthetic wood 80 is obtained by cold compression as described in the present invention, the obtained synthetic wood can be processed as required.

After the wood fibers and plastic films 82 are hot-compressed in the first compression machine 40 and cold-compressed in the second compression machine 50, synthetic wood 80 in high density can be obtained, and the synthetic wood 80 has high tenacity and high nail-holding capacity.

Those skilled in the art should appreciate that, before the wood 80a can be treated to strip off the bark before being milled, so that wood fibers with less impurity can be obtained. In addition, the wood 80a can be cooked after being treated to strip off the bark, so that it can be milled into fibers more easily.

In the present invention, the conditions of hot compression and cold compression can be selected in a wide range, and can be adjusted according to the actual requirements. Preferably, the hot compression conditions include: the hot compression temperature is 120° C. or higher, preferably is 150-240° C.; the pressure is 16 tons per square meter of wood fibers or higher, preferably 32-340 tons per square meter of wood fibers. Preferably, the cold compression conditions include: the cold compression temperature is 90° C. or lower, preferably is 0-75° C. the pressure is 16 tons per square meter of wood fibers or higher, preferably 25-405 tons per square meter of wood fibers. In the present invention, the hot compression temperature and cold compression temperature refer to the surface temperature of the components that contact with the wood fibers in the machine that applies hot compression or cold compression, such as the compression machine.

In the present invention, the duration of hot compression and cold compression can be selected in a wide range, according to the total thickness of all wood fibers layers to be compressed. For wood fibers in 1 mm total thickness, the hot compression duration is preferably 1-5 min, more preferably 1.5-3 min; and the cold compression duration is preferably 1-5 min, more preferably 1.5-3 min.

In the present invention, the consumption rate of the plastic film 82 can be selected in a wide range. The consumption rate of the plastic film 82 is preferably 50 g/m2, more preferably 70-200 g/m2. The above-mentioned consumption rate refers to 50 g plastic film per square meter of bound surface, preferably 70-200 g plastic film per square meter of bound surface. For two adjacent layers of wood fibers bound together, the bound surface refers to the surface of the wood fiber layer that has smaller surface area.

In the present invention, the plastic film 82 can be any plastic film in the prior art. Preferably, the plastic film contains one or more of polyethylene, polyvinyl chloride, polypropylene, and ethylene-propylene copolymer. More preferably, the plastic film contains one or more of polyethylene, polypropylene, and ethylene-propylene copolymer. With the plastic film described above, the formaldehyde pollution problem incurred by using an existing adhesive (e.g., urea-formaldehyde resin) in the prior art as the binder can be solved.

In the present invention, the thickness of the plastic film can be selected in a wide range. The thickness of the plastic film 82 is preferably 0.05-1.2 mm, more preferably 0.07-0.12 mm.

There is no special requirement for the meltability of the plastic film 82 in the present invention, but preferably the melting temperature of the plastic film is 120-240° C.

After wood fibers 80c are obtained by milling machine, the wood fibers 80c can be stacked in an alternate manner with the plastic films 82. And then the wood fibers 80c and plastic films 82 are hot-compressed and cold-compressed, so as to obtain synthetic wood 80.

To prevent the wood fiber 80c from getting loose in the follow-up processing process, preferably a layer of formaldehyde-free binder is applied on the surface of the wood fibers 80c outputted through the outlet of the milling machine. The amount of the binder doesn't have to be more than just enough to prevent the wood fibers 80c from getting loose in the follow-up process.

To facilitate subsequent processing of the wood fibers 80c obtained from the milling machine, preferably the production system comprises a conveyer belt 60 between the milling machine and the first compression machine 40, and a glue spraying device 70 is arranged above the conveyer belt 60. The conveyer belt 60 is designed to convey the wood fibers to the next section, and the glue spraying device 70 is used to bind together the wood fibers 80c obtained from the milling machine, to prevent the wood fibers 80c from getting loose in the follow-up procedure.

Preferably, the glue spraying device 70 is a glue line extruding machine. That is to say, the glue for binding the wood fibers 80c extruded from the glue spraying device 70 is in a linear form. Thus, the consumption of the glue can be reduced. In addition, the glue line extruding machine can extrude glue with good adhesiveness, so as to prevent the wood fibers 80c from getting loose.

Preferably, the production system comprises a drying device 90, which is arranged in downstream of the glue spraying device 70 and adjacent to the glue spraying device 70 in a way that the conveyer belt 60 can move through the drying device 90. The wood fibers spayed by glue are dried by the drying device 90, so that they are bonded together more firmly, and high-quality synthetic wood 80 can be obtained in the follow-up hot compression procedure and cold compression procedure. As described above, the drying device 90 can be a tunnel type drying oven.

To facilitate control, preferably the drying device 90 is an infrared-ray dryer.

To feed the wood fibers into the first compression machine 40 more easily, the wood fibers 80c outputted from the milling machine can be cut into predefined length and width.

In the present invention, the wood fibers 80c can be cut into predefined length and width manually. To improve working efficiency and save manpower, preferably the production system comprises a cutting device, which is arranged adjacently in upstream of the first compression machine 40. Before the wood fibers are conveyed to the first compression machine 40, the wood fibers are cut by the cutting device into wood fiber plates 81 in predefined length and width, and the wood fiber plates 81 and plastic films 82 are arranged in an alternate manner between the two templates of the first compression machine 40. Here, the cutting device can be any device that can cut wood fibers, such as a plate shearing machine. In addition, the cutting device is also helpful for producing synthetic wood producted in different specifications.

Hereunder the operating process of the production system for producing synthetic wood in the present invention will be detailed with reference to FIG. 2.

First, the wood 80a to be processed (salix mongolia branches) are fed by the material feeding device 20 of the milling machine into the compression device 10. The upper roller 11 of the compression device 10 drives the upper frictional belt 13 to move, and the lower roller 12 drives the lower frictional belt 14 to move. The gap between the side of the upper frictional belt 13 and the side of the lower frictional belt 14 that face each other decreases gradually from upstream to downstream, and the wood 80a to be processed becomes wood 80b in the milling process after entering into the gap. So the wood 80b in the milling process moves gradually towards downstream along with the upper frictional belt 13 and lower frictional belt 14, and are milled into wood fibers completely, the wood fibers are outputted from the milling machine through the die 30 and form wood fibers 80c, wherein, the cross section of the wood fibers 80c is in the same shape as the outlet of the die 30. The wood fibers 80c outputted from the die 30 is conveyed by the conveyer belt 60 to a position under the glue spraying device 70, where the glue lines extruded from the glue spraying device 70 bind the wood fibers 80c together.

The wood fibers bound together are conveyed by the conveyer belt to the drying device 90, where the glue on the wood fibers is cured and the wood fibers are dried. Then, the dried and bonded wood fibers are conveyed by the conveyer belt 60 to the cutting device, where the dried and bonded wood fibers are cut into wood fiber plates 81 in predefined length and width.

Next, the wood fiber plates 81 and plastic films 82 are arranged in an alternate manner between the two templates of the first compression machine 40, and the wood fiber plates 81 and plastic films 82 are heated and compressed, so that the plastic films 82 are melted and the wood fiber plates 81 are bound up.

Finally, the wood fiber plates 81 bound by the molten plastic films are placed between the two templates of the second compression machine 50 and are compacted and held for a certain period, to obtain finished synthetic wood.

The milling machine described in the present invention comprises an upper roller and a lower roller, wood is compressed between the upper roller and the lower roller so that wood fibers are obtained without destroying the original structure of wood fibers. The performance of synthetic wood made from processed wood fibers is approximately equivalent to that of real wood. In addition, there is no formaldehyde added in the synthetic wood produced by the system for producing synthetic wood described in the present invention, the production cost of synthetic wood is reduced, and a purpose of energy conservation and environmental protection is realized.

While some preferred embodiments of the present invention are described above with reference to the accompanying drawings, the present invention is not limited to the details in those embodiments. Those skilled in the art can make modifications and variations to the technical scheme of the present invention, without departing from the spirit of the present invention. However, all such modifications and variations shall be deemed as falling into the protected domain of the present invention.

In addition, it should be appreciated that the technical features described in the above embodiments can be combined in any appropriate manner, provided that there is no conflict among the technical features in the combination. To avoid unnecessary iteration, such possible combinations are not described here in the present invention.

Moreover, different embodiments of the present invention can be combined freely as required, as long as the combinations don't deviate from the ideal and spirit of the present invention. However, such combinations shall also be deemed as falling into the scope disclosed in the present invention.

1. A wood milling machine, comprising a compression device, which comprises an upper roller and a lower roller rotating in opposite directions with a gap between thereof.

2. The milling machine according to claim 1, wherein, the gap between the upper roller and the lower roller is adjustable.

3. The milling machine according to claim 1, wherein, the compression device comprises a plurality of the upper rollers arranged side by side in a row, and a plurality of the lower rollers arranged side by side in a row.

4. The milling machine according to claim 3, wherein, the compression device comprises an upper frictional belt surrounding the plurality of upper rollers and a lower frictional belt surrounding the plurality of lower rollers, wherein, the upper frictional belt can be driven by the upper rollers to move, and the lower frictional belt can be driven by the lower rollers to move, and there is a gap between a side of the upper frictional belt 13 and a side of the lower frictional belt 14 that face each other.

5. The milling machine according to claim 4, wherein, the gap between the side of the upper frictional belt and the side of the lower frictional belt that face each other decreases gradually from upstream to downstream.

6. The milling machine according to claim 4, wherein, the outer surface of the upper frictional belt and/or the outer surface of the lower frictional belt have patterns, to increase the friction force between the wood and the upper frictional belt and/or lower frictional belt.

7. The milling machine according to claim 4, wherein, the movement speed of the upper frictional belt is not equal to the movement speed of the lower frictional belt.

8. The milling machine according to claim 7, further comprising a first speed regulating device designed to regulate the rotation speed of the upper rollers and/or a second speed regulating device designed to regulate the rotation speed of the lower rollers.

9. The milling machine according to claim 8, further comprising a first motor which is designed to drive the upper roller to rotate and is a first frequency converter electrically connected to the first motor, and/or a second motor which is designed to drive the lower roller to rotate and is a second frequency converter electrically connected to the second motor.

10. The milling machine according to claim 4, wherein, a tension pulley is arranged on the upper frictional belt and/or the lower frictional belt.

11. The milling machine according to any of claims claim 4, further comprising a material feeding device with a wood channel, wherein, the material feeding device is arranged in upstream to the compression device, and the wood channel communicates with the gap between the side of the upper frictional belt and the side of the lower frictional belt that face each other.

12. The milling machine according to claim 4, further comprising an die arranged at the outlet of the compression device, wherein, the die communicates with the gap between the side of the upper frictional belt and the side of the lower frictional belt that face each other.

13. The milling machine according to claim 12, wherein, the die is in the same width as the gap between the upper frictional belt and the lower frictional belt.

14. A system for producing synthetic wood, comprising a milling machine, a first compression machine, and a second compression machine, which are arranged sequentially from upstream to downstream, wherein, the milling machine is the milling machine as set forth in any of claims 1-13, and the first compression machine is equipped with a heating device designed to heat up templates of the first compression machine.

15. The production system according to claim 14, further comprising a conveyer belt disposed between the milling machine and the first compression machine, with a glue spraying device arranged above the conveyer belt.

16. The production system according to claim 15, wherein, the glue spraying device is a glue line extruding machine.

17. The production system according to claim 15, further comprising a drying device, which is arranged in downstream of the glue spraying device and adjacent to the glue spraying device in a way that the conveyer belt can move through the drying device.

18. The production system according to claim 17, wherein, the drying device is an infrared-ray dryer.

19. The production system according to claim 14, further comprising a cutting device, which is arranged in the upstream of the first compression machine and is adjacent to the first compression machine.
